(19) United States
(12) Patent Application Publication
(10) Pub. No.: US 2026/0318374 A1
(43) Pub. Date: Oct. 15, 2026

(54) DUAL LOCKING MECHANISM FOR A TELESCOPIC BRAKE ASSEMBLY

(71) Applicant: Aspen Medical Products, LLC, Irvine, CA (US)

(72) Inventors: Mark Caniga, Huntington Beach, CA (US); Erik Zimmer, Oeanside, CA (US); Jonathan Breen, Laguna Niguel, CA (US); Albert V. Romo, Lakewood, CA (US)

(21) Appl. No.: 19/647,681

(22) Filed: Apr. 14, 2026

Related U.S. Application Data
(60) Provisional application No. 63/789,315, filed on Apr. 15, 2025.
(60) Provisional application No. 63/913,973, filed on Nov. 7, 2025.
(60) Provisional application No. 63/916,148, filed on Nov. 12, 2025.

(51) Int. Cl. F16D 63/00; F16D 121/14; F16D 125/32; F16D 127/06

(52) U.S. Cl. CPC F16D 63/008; F16D 2121/14; F16D 2125/32; F16D 2127/06

(57) ABSTRACT

A telescopic brake assembly features a telescopic casing, a pair of brake pads, and a tightening lever. The telescopic casing includes a first cavity, a second cavity, and a raised attachment region extending from a top surface of the telescopic casing. A first brake is partially inserted within the first cavity, and a second brake pad is partially inserted within the second cavity. The tightening lever including a pair of arms rotatably attached to the raised attachment region, including both the first and second arms extending outwardly towards a proximal end of the telescopic casing from a single point of intersection. The single point of intersection includes a snap lock configured to engage with a protrusion positioned along a distal edge of the raised attachment region to necessitate more force in transitioning the tightening lever from a closed state to an open state than transitioning the tightening lever from the open state to the closed state.

### CROSS-REFERENCE TO RELATED APPLICATIONS

This application claims the benefit of priority on U.S. Patent Application No. 63/789,315 filed Apr. 15, 2025, U.S. Patent Application No. 63/913,973 filed Nov. 7, 2025, and U.S. Patent Application No. 63/916,148 filed Nov. 12, 2025, the entire contents of each of these provisional US patent applications are incorporated by reference herein.

### FIELD

Embodiment of the invention relate to orthopedic braces (orthoses), and in particular, a telescopic brake system for an orthopedic brace with a double locking mechanism.

### GENERAL BACKGROUND

Orthopedic braces are worn on the body of a user either to support a skeletal joint that is at risk of injury or has been destabilized due to injury. Orthopedic braces generally include rigid, structural components, which are dynamically linked together by one or more hinge assemblies. These hinge assemblies allow for structural components of the orthopedic brace to be vertically adjusted, thereby controlling pivotal movement of the skeletal joint more precisely during activity or rehabilitative therapy. In many situations, especially following surgery, an orthotist may adjust positioning of these structural components to increase or decrease mobility in favor of stability, and vice versa.

For example, a conventional orthopedic brace may feature multiple hinge assemblies, where these conventional hinge assemblies are designed to control movement of a strut and positioning of a neighboring structural component in relation to the hinge assembly. Also, conventional hinge assemblies utilize a lock level located along an edge of the hinge assembly controls fastening and unfastening of the strut. This positioning of the lock lever is difficult to use by users trying to re-install the orthopedic brace after temporary removal. Also, the hinge utilizes a single brake component that comes into contact with a narrow, lateral area of the strut. This prevents deployment of a redundant (multiple brakes) to ensure that the locations assigned to the structural components remain fixed.

### BRIEF DESCRIPTION OF THE DRAWINGS

Embodiments of the invention are illustrated by way of example and not by way of limitation in the figures of the accompanying drawings, in which like indicate similar elements and in which:

FIG. 1 illustrates an exemplary embodiment of an orthopedic brace with a pair of lateral brace assemblies each including inverted telescopic brake assemblies.

FIG. 2A illustrates a plan view of an exemplary embodiment of a telescopic brake assembly such as the first telescopic brake assembly of FIG. 1.

FIG. 2B illustrates a side view of the telescopic brake assembly of FIG. 2A

FIG. 2C illustrates a bottom view of the telescopic brake assembly of FIG. 2A.

FIG. 3 illustrates an exploded view of an exemplary embodiment of the telescopic brake assembly of FIG. 2A.

FIG. 4A illustrates an exemplary embodiment of a strap clamp configured to attachment to a clamp holder integrated as part of a telescopic casing of the telescopic brake assembly of FIG. 3.

FIG. 4B illustrates an exemplary embodiment of the strap clamp engaged with the clamp holder of FIG. 4A and positioned in an unlocked (disengaged) state.

FIG. 4C illustrates an exemplary embodiment of the strap clamp engaged with the clamp holder of FIG. 4A and positioned in a locked (engaged) state.

FIG. 5A illustrates a plan, top view of exemplary embodiment of a tightening lever for the telescopic brake assembly of FIG. 3.

FIG. 5B illustrates a plan, bottom view of the tightening lever of FIG. 5A.

FIG. 6A illustrates a left-facing perspective view of a clamp key being a component installed within the telescopic brake assembly of FIG. 3.

FIG. 6B illustrates a plan view of the clamp key of FIG. 6A.

FIG. 6C illustrates a right-facing perspective view of the clamp key of FIGS. 6A-6B.

FIG. 7 illustrates a perspective view of a portion of the telescopic brake assembly of FIG. 3.

FIG. 8A illustrates a lateral (side) view of the telescopic brake assembly of FIG. 3.

FIG. 8B illustrates a lateral (side) view of the telescopic brake assembly of FIG. 3 with the tightening lever placed into a locked (engaged) state without installation of a second clamp key.

FIG. 8C illustrates a lateral (side) view of the telescopic brake assembly of FIG. 3 with the tightening lever placed into an unlocked (disengaged) state.

FIG. 8D illustrates a lateral (side) view of the telescopic brake assembly of FIG. 8C without installation of a second clamp key.

FIG. 9 illustrates a perspective view of the clamp key of FIGS. 6A-6C engaged with the tightening lever of FIGS. 5A-5B and adapted to maintain a brake pad positioned to be depressed by a cam component of the tightening lever.

FIG. 10A illustrates a perspective view of the clamp key of FIGS. 6A-6C with a rod component engaged with a raised attachment region integrated as part of a top surface of the telescopic casing of the telescopic brake assembly of FIG. 3.

FIG. 10B illustrates a perspective view of the clamp key of FIG. 10A with the attachment rod inserted through a pass-through aperture of the second arm of the tightening lever of FIG. 5A and attached to the telescopic casing of FIG. 4A.

FIG. 10C illustrates a perspective view of the clamp key of FIG. 10B with the attachment rod of the second clamp key inserted through a pass-through aperture of second arm of the tightening lever of FIG. 5A with the tightening lever and the telescopic casing represented in ghost imagery.

FIG. 11A illustrates a perspective view of the second clamp key of FIGS. 6A-6C positioned within a cavity formed in the telescopic casing in which the back wall of the clamp key is generally aligned with a lateral surface of a rail member of the telescopic casing and the tightening lever is positioned in a locked (engaged) state.

FIG. 11B illustrates a perspective view of the second clamp key 240 of FIG. 11A with the back wall of the clamp key generally aligned with the lateral surface of the rail member of the telescopic casing and the tightening lever positioned in an unlocked (disengaged) state.

FIG. 12A illustrates a more detailed rear view of the second clamp key of FIG. 11A.

FIG. 12B illustrates a notch within a rail member of the telescopic casing positioned for engagement with an angled undercut formed at the edge of the base segment of the second clamp key.

FIG. 13 illustrates a plan view of an exemplary embodiment of a stop inserted into a prescribed slot of the telescopic casing for prevention and removal of a strut member partially residing in the telescopic brake assembly.

FIGS. 14A-14H illustrates an exemplary sequence of operations for construction of the hinge assembly of FIG. 3.

FIGS. 15A-15F illustrates an exemplary sequence of operations for donning of the orthopedic brace of FIG. 1. While the design is subject to various modifications, equivalents, and alternative forms, specific embodiments thereof have been shown by way of example in the drawings and are described below in detail. It should be understood that the design is not limited to the particular embodiments disclosed, but on the contrary, the intention is to cover all modifications, equivalents, and alternative forms using the specific embodiments as an illustrative example of the inventive aspects described herein.

### DETAILED DESCRIPTION

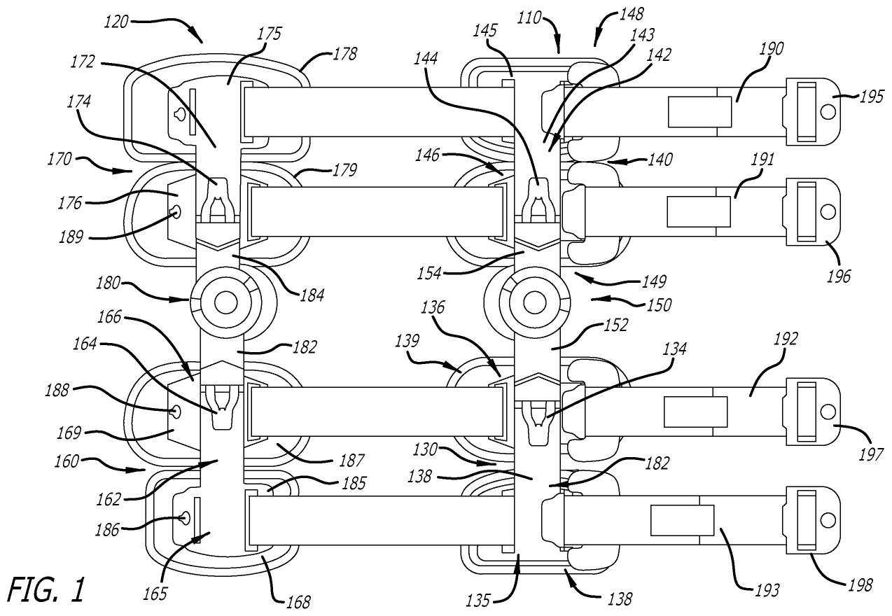

Embodiments of the present disclosure generally relate to a telescopic brake assembly configured to be deployed as part of an orthopedic brace, such as a knee brace, leg brace, shoulder brace, or back brace for example. According to one embodiment of the disclosure, the telescopic brake assembly features a telescopic casing, a strap clamp, a tightening lever, a plurality of clamp keys and a plurality of brake pads arranged for engagement with a strut inserted within the telescopic casing and a cam of the tightening lever when the telescopic brake assembly is placed in a locked state. Within an orthopedic brace, multiple versions of telescopic brake assemblies may be installed such as one or more telescopic brake assemblies configured with strap fastening subassemblies along with one or more corresponding telescopic brake assemblies configured with strap retention subassemblies, as illustrated in FIG. 1 shown below.

Herein, the telescopic casing of a telescopic brake assembly includes a distal end and a proximal end. According to one embodiment of the disclosure, the distal end features a first strap fastening subassembly, which includes a strap guide plate integrated as part of the telescopic casing and including a first strap opening, a second strap opening, and a clamp holder positioned proximate to the second strap opening. The first strap fastening subassembly is utilized to tighten a strap, which is fed through the first and second strap openings and terminated at both end to a first strap retention subassembly coupled to another telescopic brake assembly positioned on opposite side of an appendage of the user from the first strap fastening subassembly. The strap clamp is attached to the clamp holder of the first strap fastening subassembly, where the strap clamp is retained in an open position during shipment and during the initial donning process by clamp positioning guides.

The proximal end of the telescopic casing includes a raised attachment region having a first set of openings accessible from a first lateral side of the attachment region and a second set of openings accessible from a second lateral side of the attachment region. Herein, according to this embodiment of the disclosure, the tightening lever includes a pair of arms, where a distal end of each arm features a cam and a pass-through aperture. The pass-through aperture is aligned with a corresponding opening of the first (or second) set of openings. The tightening lever further includes a snap lock positioned at an intersecting region of the pair of arms. The snap lock engages with a ledge (protrusion) positioned on a distal edge of the raised attachment region.

Herein, as described below, a radial distance of a proximal (top) corner portion of the cam is greater than the radial distance of the cam to a flat segment of the cam where the brake pad seats when engaged. Hence, to place the tightening lever into a locked state, the brake pad would need to overcome the longer, proximal corner portion before settling onto flat segment. As the cam features a greater radial distance to the proximal corner portion than the flat segment, once the brakes are engaged, the cam layout operates as a locking feature that retains the tightening lever in the horizontal position and prevents the tightening lever from being rotated back thereby acting as a locking feature.

Herein, a second strap fastening subassembly may be configured as a separate component. For example, the second strap fastening subassembly may be positioned under the telescopic casing of the telescopic brake assembly, where the second strap fastening subassembly is attached to a padded shell support and a strut insertable into a proximal opening of the telescopic casing. As an alternative embodiment, the second strap fastening subassembly may be integrated as part of the proximal end of the telescopic casing (and coupled to the padded shell support). Herein, the telescopic brake assembly with the first strap fastening subassembly and the second strap fastening subassembly, with the padded supports, form a lower or upper portion of a first lateral brace assembly for an orthopedic brace.

A first clamp key includes a back wall with a first attachment rod, a first rotation prevention wall, a first pair of brake pad support arms, and a first base segment extending therefrom. The attachment rod is arranged for insertion through a pass-through aperture of a first arm of the tightening lever and insertion into a first opening of the first set of openings formed within the raised attachment region. The rotation prevention wall is arranged for insertion into a second opening of the first set of openings, which is positioned laterally and distally from the first opening. The brake pad support arms are configured to support a first brake pad with a strut member inserted between a bottom side of the brake pad and the first base segment. The first base segment includes an angled undercut formed at the edge of the base segment of the first clamp key, which snaps into a corresponding slot on a bottom portion of the telescopic casing to securely attach the first clamp key to the telescopic casing.

Similarly, the second clamp key includes a back wall with a second attachment rod, a second rotation prevention wall, a second pair of brake pad support arms, and a second base segment extending therefrom. The second attachment rod is arranged for insertion through a pass-through aperture of a second arm of the tightening lever and insertion into a first opening of the second set of openings. The rotation prevention wall is arranged for insertion into a second opening of the second set of openings, which is positioned laterally and distally therefrom. The second pair of brake pad support arms are configured to support a second brake pad with a strut insertable between a bottom side of the brake pad and the second base segment. The second base segment includes a flexible protrusion that snaps into a corresponding slot on a bottom portion of the telescopic casing to securely attach the second clamp key to the telescopic casing. The dual brake pads provides more reliable and stronger retention of the strut member to prevent unnecessary movement.

According to this embodiment of the disclosure, the tightening lever has a rotational plane perpendicular to the travel direction (movement) of the strut member. When the tightening lever is placed into a locked state, the cam (positioned for each of the lever arms) comes into contact with the brake pads above a top surface of the telescopic casing and depress the pair of brake pads, thereby applying downward forces against the strut positioned between the pair of brake pads and the first/second base segments. This prevents movement of the strut member when the tightening lever is placed into the locked state. Alternatively, when the tightening lever is placed into an unlocked state, the rotation prevention wall is oriented to prevent full rotation of the tightening lever.

Additionally, a stop (pin) inserted into a prescribed opening of the telescopic casing after placement of the strut, where the stop may be permanently affixed to the telescopic casing (heat-sealed) or may be removably affixed (removable screw or dowel). The stop is positioned to engage with a tab extending from an edge of the strut after the strut has extended from the telescopic casing by a prescribed distance. The stop is designed to prevent accidental removal of the strut from the telescopic casing.

### I. Terminology

In the following description, certain terminology is used to describe aspects of the invention. For example, the term “patient” or “user” includes both humans and animals, independently of whether the patient (or user) is under the care of a medical or veterinary professional.

The term “assembly” is intended to identify a group of components forming part of an orthopedic brace. Similarly, the terms “member” and “element” are used to identify a particular type of component.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The character set “(s)” denotes one or more items. For example, the term “strap(s)” denotes one or more straps. The term “rod(s)” denotes one or more rods. The term “straps(s)” denotes one or more straps, and the like. The character set “/” between two reference numerals denotes “and/or” as defined below. For example, “100/110” denotes “100 and 110” or alternatively “100 or 110”.

Finally, the terms “or” and “and/or” as used herein are to be interpreted as inclusive or meaning any one or any combination. As an example, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

All methods or orthopedic brace aspects described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Various objects, features, aspects, and advantages of the inventive subject matter will become more apparent from the following detailed description of preferred embodiments, along with the accompanying drawing figures in which numerals represent like components.

### II. General Architecture-Orthopedic Brace

The following discussion provides illustrative embodiments of different inventive subject matter. Although each embodiment may represent a single combination of inventive elements, each inventive aspect may be considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

In some embodiments, the numbers expressing quantities of properties such as sizing, degrees of motion, and so forth, may be described in connection with certain embodied inventive aspect, but these quantities may be modified while still retaining the spirit and scope of the disclosed invention. Accordingly, in some embodiments, the numerical parameters set forth in the written description are illustrative approximations that can vary depending upon the desired properties sought to be obtained by a particular embodiment.

Groupings of inventive embodiments disclosed herein are not to be construed as limitations. Each inventive embodiment, as well as each illustrative component or feature within an inventive embodiment, can be referred to and may be claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified.

Referring to FIG. 1, an exemplary embodiment of an orthopedic brace 100 featuring a first lateral brace assembly 110 and a second lateral brace assembly 120 is shown. The first lateral brace assembly 110 includes a first telescopic brake assembly 130, a second telescopic brake assembly 140, and a first joint control hinge member 150 interposed between the first telescopic brake assembly 130 and the second telescopic brake assembly 140. The first joint control hinge member 150 is coupled to a first strut member 152 and a second strut member 154, which are partially retained within the first telescopic brake assembly 130 and the second telescopic brake assembly 140, respectively. According to one embodiment of the disclosure, the strut members, such as the first strut member 152 and/or the second strut member 154, may have a coating that is adapted to provide additional friction in response to movement of the strut when in contact with its corresponding brake pad

As further shown, the joint control hinge member 150 is adapted to control the degree of pivot for the first and second strut members 152 and 154, which controls the degree of extension and flexion permitted for a lateral/medial region of the user's body part depending on which leg it is worn. (e.g., knee). The first and second telescopic brake assemblies 130 and 140 are configured to retain strap fastening subassemblies adapted to operate as a first fastening/tightening mechanism for the orthopedic brace 100.

Similarly, the second lateral brace assembly 120 includes a third telescopic brake assembly 160, a fourth telescopic brake assembly 170, and a second joint control hinge member 180 interposed between the third telescopic brake assembly 160 and the fourth telescopic brake assembly 170. The second joint control hinge member 180 is coupled to a third strut member 182 and a fourth strut member 184, which are partially retained within the third telescopic brake assembly 160 and the fourth telescopic brake assembly 170, respectively. The second joint control hinge member 180 is adapted to control the degree of pivot for the third and fourth strut members 182 and 184, which controls the degree of extension and flexion permitted for a lateral/medial knee region depending on which leg it is worn when the orthopedic brace 100 is a knee brace.

As further shown in FIG. 1, the first telescopic brake assembly 130 of the first lateral brace assembly 110 features a telescopic casing 132 and a tightening lever 134 mounted on a top surface 133 of the telescopic casing 132. The vertical positioning of the first telescopic brake assembly 130 along the first lateral brace assembly 110 may be set by adjusting the length of the first strut member 152 partially inserted into the telescopic casing 132 and setting the tightening lever 134 into a locked state. When set into a locked state, the tightening lever 134 is configured to apply downward forces against the first strut member 152, where these forces prevent further movement of the first telescopic brake assembly 130 along the first strut member 152.

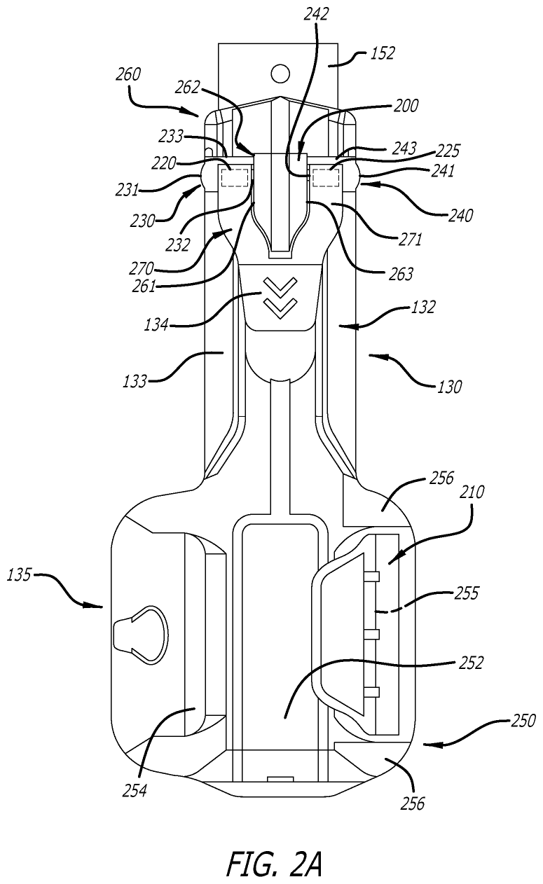

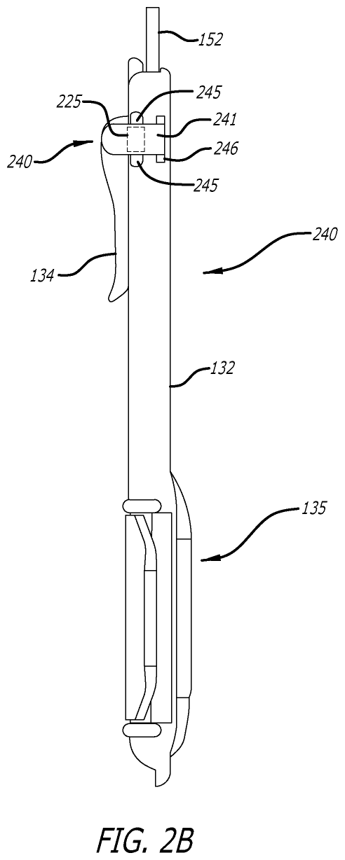

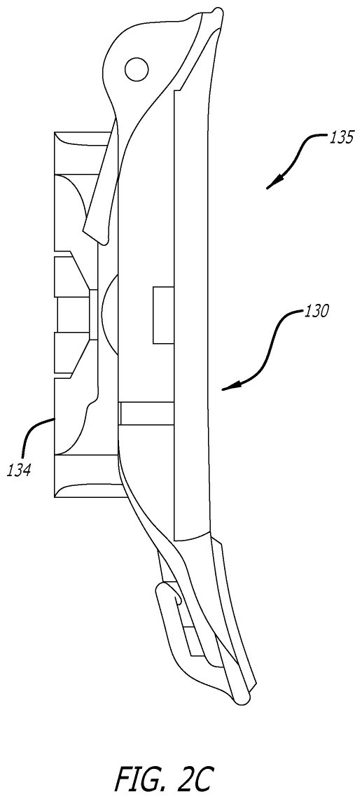

When the tightening lever 134 is placed into an unlocked state, the telescopic casing 132 of the first telescopic brake assembly 130 may be moved upward or downward along the first strut member 152 to adjust the separation distance between strap fastening subassemblies 135 and 136. According to this embodiment, a first strap fastening subassembly 135 is integrated as part of the telescopic casing 132 and coupled to a first cuff (shell support) 138 while a second strap fastening subassembly 136, installed as a separate component from the telescopic casing 132, is coupled to a second cuff 139. Each of the strap fastening subassemblies 135/136 include a strap guide plate integrated as part of the telescopic casing and including a first strap opening, a second strap opening, and a clamp holder positioned proximate to the second strap opening, as shown in more detail in FIGS. 2A-2C.

Similar in construction, the second telescopic brake assembly 140 of the first lateral brace assembly 110 features a telescopic casing 142 and a tightening lever 144 mounted on a top surface 143 of the telescopic casing 142. The vertical positioning of the second telescopic brake assembly 140 along the first lateral brace assembly 110 may be set by adjusting the length of the second strut member 154 partially inserted into the telescopic casing 142 and setting the tightening lever 144 into a locked state. When set into a locked state, the tightening lever 144 is configured to apply downward forces to the second strut member 154 to prevent further movement of the second telescopic brake assembly 140 along the second strut member 154. According to this embodiment, a third strap fastening subassembly 145 may be integrated as part of the telescopic casing 142 and coupled to a third cuff (shell support) 148 while a fourth strap fastening subassembly 146, installed as a separate component from the telescopic casing 142, is coupled to a fourth cuff 149. According to one embodiment of the disclosure, the architectures of the second telescopic brake assembly 140 are identical to the first telescopic brake assembly 130.

More specifically, the telescopic casing 142 is configured with the third strap fastening subassembly 145 positioned at a distal end of the second telescopic brake assembly 140. Additionally, the telescopic casing 142 may further include the fourth strap fastening subassembly 146 positioned at the proximal end of the second telescopic brake assembly 140. However, unlike the third strap fastening subassembly 145 being integrated as part of the telescopic casing 142, the fourth strap fastening subassembly 146 may be implemented as a component separate from the telescopic casing 142, which is coupled to the fourth cuff 149 and/or the second strut member 154. The strap fastening subassemblies 145/146 may be positioned on backsides of cuffs 148/149 of the orthopedic brace 100.

As shown, each strap fastening subassemblies 145 and 146 enable two lateral straps 190 and 191 to attach the first lateral brace assembly 110 to the second lateral brace assembly 120, where the tightening/loosening of the straps 190 and 191 are situated to tighten or loosen the orthopedic brace 100 around a body part of the user. Of course, as an alternative embodiment, the fourth strap fastening subassembly 146 may be integrated as part of the telescopic casing 142 similar to the third strap fastening subassembly 145.

Additionally, as further shown in FIG. 1, the third telescopic brake assembly 160 of the second lateral brace assembly 120 features a telescopic casing 162 and a tightening lever 164 mounted on the telescopic casing 162. The vertical positioning of the third telescopic brake assembly 160 along the second lateral brace assembly 120 may be set by adjusting the length of the third strut member 182 partially inserted into the telescopic casing 162 and setting the tightening lever 164 into a locked state to prevent further movement of the third telescopic brake assembly 160 along the third strut member 182.

When the tightening lever 164 is placed into an unlocked state, the telescopic casing 162 of the third telescopic brake assembly 160 may be moved upward or downward along the third strut member 182 to adjust the separation distance between strap retention subassemblies 165 and 166. According to this embodiment, a first strap retention subassembly 165 is integrated as part of the telescopic casing 162 and coupled to a fifth cuff (shell support) 168 while the second strap retention subassembly 166, installed as a separate component from the telescopic casing 162, is coupled to a sixth cuff 169 and the third strut member 182.

As shown, the first strap retention subassembly 165 includes a strap termination component (e.g., D-ring) 185 to retain a first end of a fourth strap 193 and a fastener 186 positioned on an opposite side of the first strap retention subassembly 165 for retention of a buckle 198 coupled to a second end of the fourth strap 193. Similarly, the second strap retention subassembly 166 includes a second strap termination component (e.g., D-ring) 187 to retain a first end of a third strap 192 and a second fastener 188 positioned on an opposite side of the second strap retention subassembly 166 for retention of a buckle 197 coupled to a second end of the third strap 192.

Also, the vertical positioning of the fourth telescopic brake assembly 170 along may be set by adjusting the length of the fourth strut member 184 partially inserted into the telescopic casing 172 and setting the tightening lever 174 into a locked state. According to one embodiment of the disclosure, the architecture of the fourth telescopic brake assembly 170 is identical to the architecture of the third telescopic brake assembly 160.

As shown, when the tightening lever 174 is placed into an unlocked state, the telescopic casing 172 of the fourth telescopic brake assembly 170 may be moved upward or downward along the fourth strut member 184 to adjust the separation distance between strap retention subassemblies 175 and 176. According to this embodiment, a third strap retention subassembly 175 is integrated as part of the telescopic casing 172 and coupled to a seventh cuff (shell support) 178 while a fourth strap retention subassembly 176, installed as a separate component from the telescopic casing 172, is coupled to an eighth cuff 179. The architecture and functionality of the fourth telescopic brake assembly 170 is similar to the architecture and functionality of the third telescopic brake assembly 160.

Furthermore, as shown in FIG. 1, each of the straps 190-193 (may be configured with a strap buckle 195-198, respectively. Herein, each of the straps 190-193 vary in length with the first strap 190 having the longest duration (as the strap will be secured around a thigh of a user) while the lengths of the straps 191-193 lessening. Herein, the length of the first strap 190 is greater than the length of the second strap 191, which is greater than a length of a third strap 192, which is greater than a length of the fourth strap 193. The buckles 195-198 provide a second tightening mechanism.

### III. General Architecture-Telescopic Brake Assembly

Referring now to FIG. 2A, a plan view of an exemplary embodiment of a telescopic brake assembly, such as the first telescopic brake assembly 130 of FIG. 1, is shown. Herein, the first telescopic brake assembly 130 features the telescopic casing 132 and the tightening lever 134 mounted on the top surface 133 of the telescopic casing 132 and attached to a raised attachment region 200. Additionally, as shown in FIGS. 2A-2B, the telescopic brake assembly 130 includes a strap clamp 210, a plurality of brake pads 220/225, and a plurality of clamp keys 230/240 for retention of (i) the tightening lever 134 to surround the raised attachment region 200 and (ii) the brake pads 220/225 to prevent unintentional movement during use and ensure engagement of the pads 220/225 by the tightening lever 134 occurs above the top surface of the telescopic casing 132.

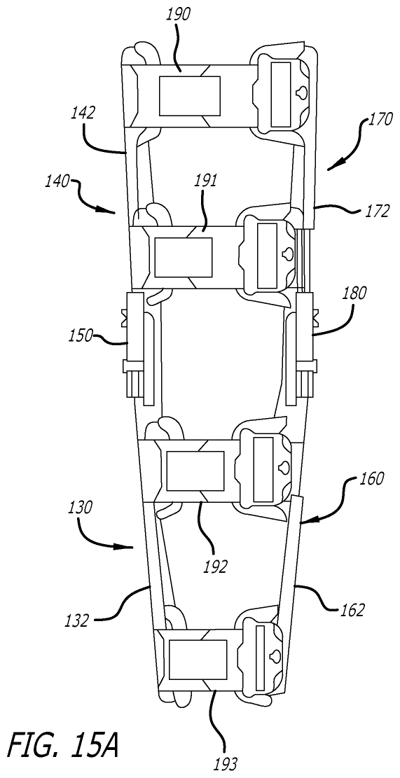

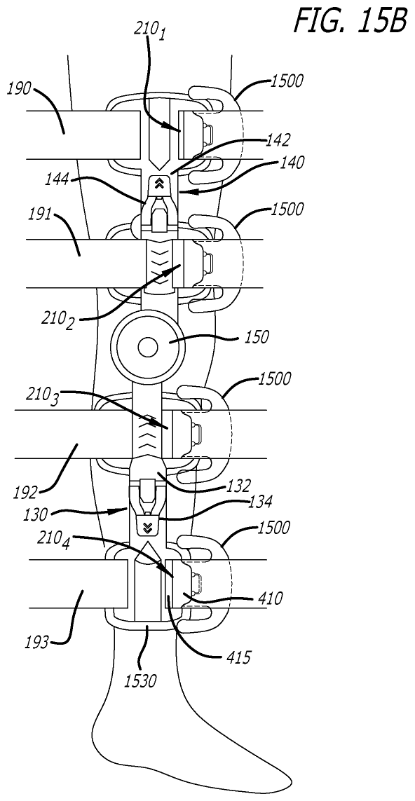

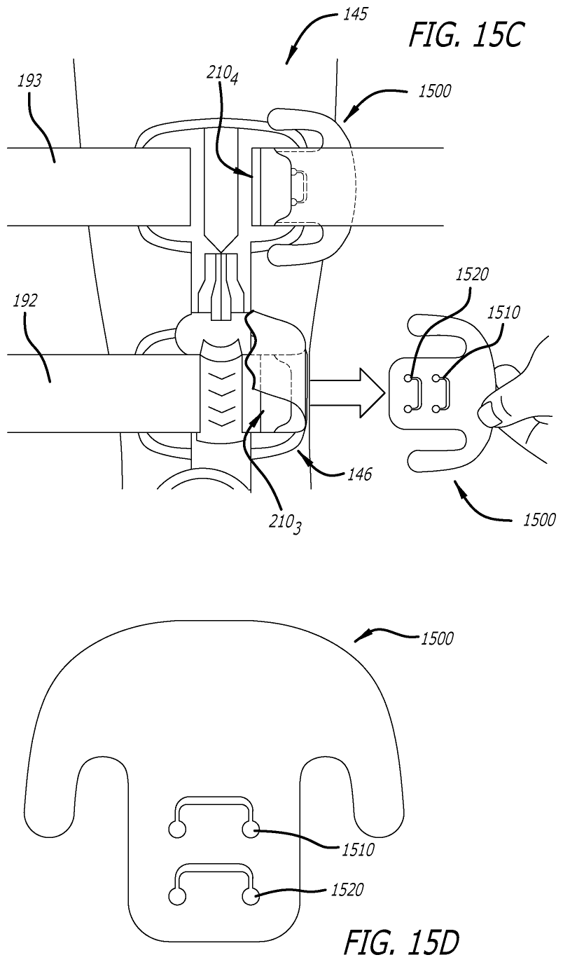

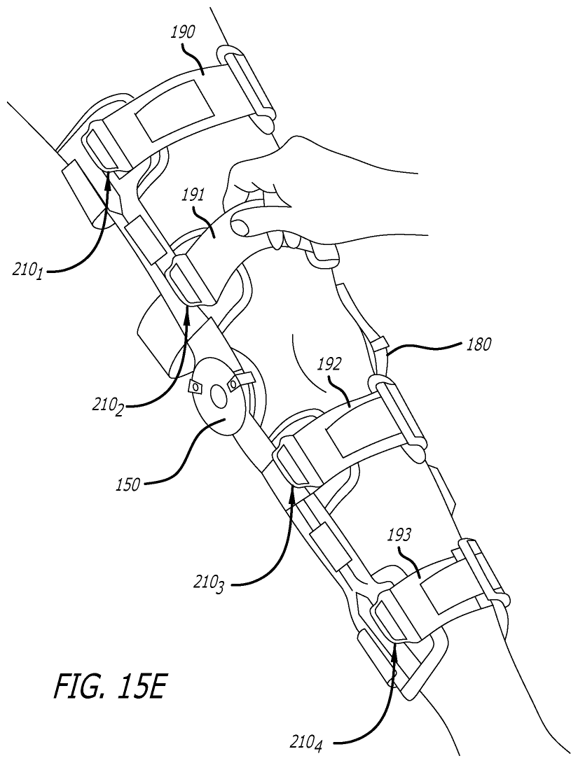

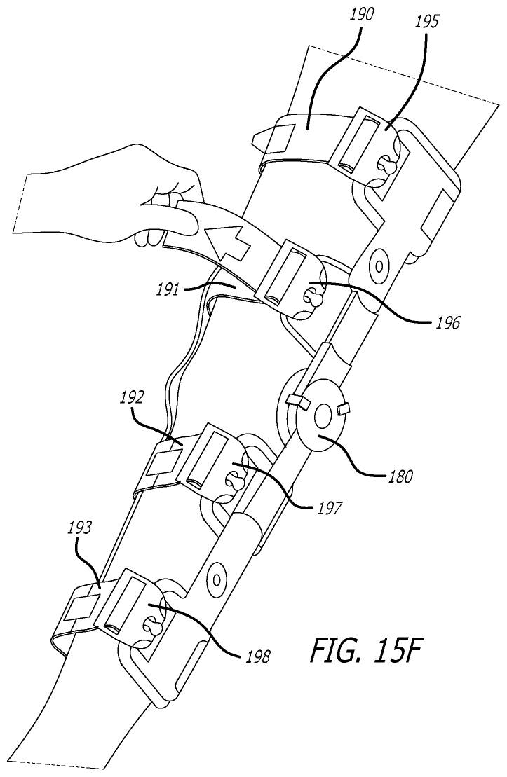

As further shown in FIG. 2A, the telescopic casing 132 includes a distal end 250 and a proximal end 260. The distal end 250 features the first strap fastening subassembly 135 integrated as part of the telescopic casing 132. The first strap fastening subassembly 135 may include a strap guide plate 252 having a first strap opening 254 and a second strap opening 255 along with a clamp holder 256 integrated as part of the second strap opening 255. The first strap fastening subassembly 135 is utilized to adjust a strap (not shown) routed through the first and second strap openings 254 and 255 when securing the orthopedic brace 100 to an appendage of the user. The strap clamp 210 is attached to the clamp holder 256, where the strap clamp 210 is retained in an open position during shipment and during the initial donning process by clamp positioning guides (see FIGS. 15A-15D). The strap clamp 210 may be placed into an unlocked (open) state (as shown) or into a locked (closed) state to prevent or restrict movement of the strap while the orthopedic brace 100 of FIG. 1 is being worn.

The proximal end 260 of the telescopic casing 132 includes the raised attachment region 200 with a first set of openings 262 accessible from a first lateral side 261 of the raised attachment region 200, and a second set of openings 264 accessible from a second lateral side 263. Although not shown in FIG. 2A, the second strap fastening subassembly 136 (see FIG. 1) may be configured as a separate component attached to the bottom or lateral surface of the telescopic casing 132 and/or the first strut member 152. Herein, according to this embodiment of the disclosure, the tightening lever 134 includes a pair of arms 270-271 with pass-through apertures located at the distal end of each arm. The arms 270-271 are arranged to straddle the raised attachment region 200 so that a pass-through aperture associated with a first arm 270 of the tightening lever 134 is aligned a corresponding opening of the first set of openings 262 to receive a first attachment rod 232 from a first clamp key 230 and a pass-through aperture associated with a second arm 271 of the tightening lever 134 is aligned a corresponding opening of the second set of openings 264 to receive a second attachment rod 242 from a second clamp key 240.

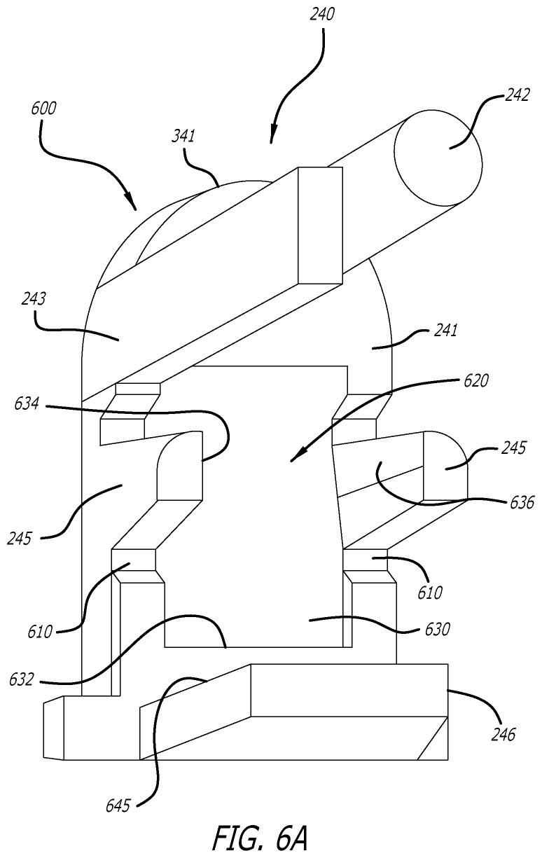

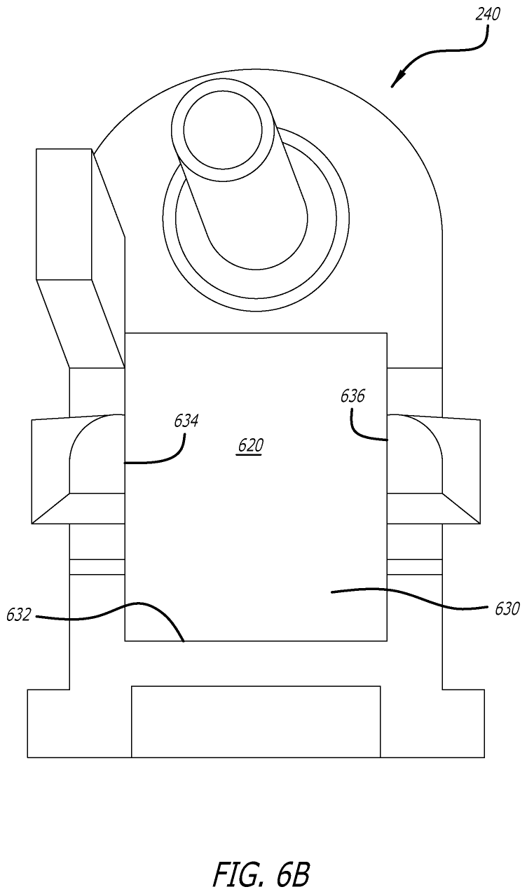

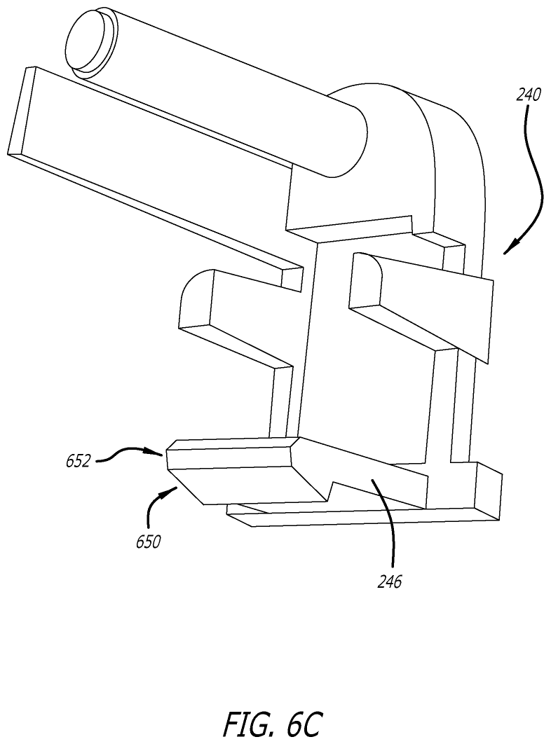

Herein, as described in more detail in FIGS. 6A-6C, the first clamp key 230 includes a back wall 231 with the first attachment rod 232 and a first rotation prevention wall 233 extending therefrom. The attachment rod 232 is arranged for insertion through the pass-through aperture associated with the first arm 270 of the tightening lever 144, which is aligned a first opening of the first set of openings 262. The first rotation prevention wall 233 is arranged for insertion into another opening of the first set of openings 262, which is positioned laterally and distally from the first opening. Similarly, the second clamp key 240 includes a back wall 241 with a second attachment rod 242 and a second rotation prevention wall 243 extending therefrom. The second attachment rod 242 is arranged for insertion through the pass-through aperture associated with the second arm 271 of the tightening lever 144 aligned with a second opening of the second set of openings 264. The second rotation prevention wall 243 is arranged for insertion into another opening of the second set of openings 264, which is positioned laterally and distally from the second opening.

Referring to FIG. 2B, a side view of a telescopic brake assembly, such as the first telescopic brake assembly 130 of FIG. 2A, is shown. Herein, the back wall 241 of the second clamp key 240 is further configured with a pair of brake pad support arms 245, and a base segment 246 extending therefrom. The brake pad support arms 245 are configured to store and/or support a second brake pad 225 with the second strut member insertable between a bottom side of the brake pad 225 and a top surface of the base segment 246. The base segment 246 includes an angled undercut protrusion that snaps into a corresponding slot on a bottom portion of the telescopic casing 132 to securely attach the second clamp key 240 to the telescopic casing 132. A rear view of the first telescopic brake assembly 130 is shown in FIG. 2C, which illustrates that the tightening lever 134 is positioned proximally to and above the first strap fastening subassembly 135.

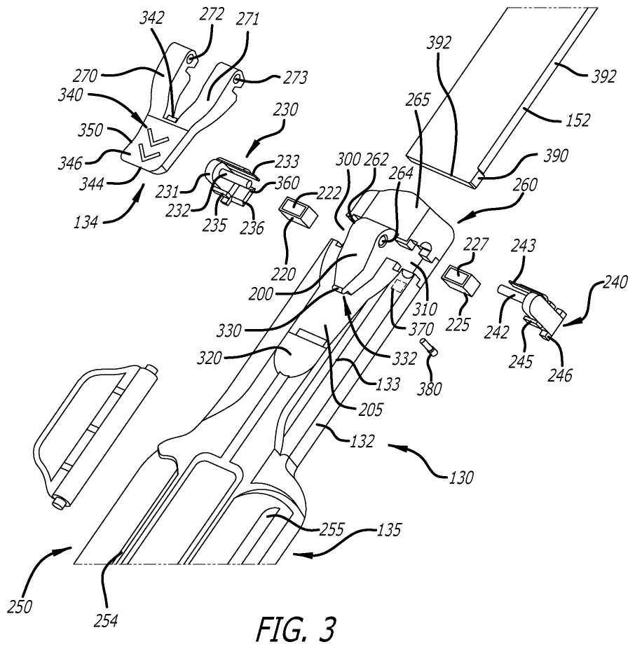

Referring now to FIG. 3, an exploded view of an exemplary embodiment of the first telescopic brake assembly 130 of FIG. 2A is shown. For this embodiment, the first telescopic brake assembly 130 corresponds in architecture to the second telescopic brake assembly 140 of FIG. 1. Moreover, the first telescopic brake assembly 130 is similar in architecture to the third and fourth telescopic brake assemblies 160 and 170, except each of the telescopic brake assemblies 160 and 170 include a strap termination component (e.g., D-ring) and a fastener complementary to a buckle in lieu of the strap clamp 210.

As shown, the first telescopic brake assembly 130 includes the telescopic casing 132 and the strap fastening subassembly 135 with strap openings 254 and 255 integrated as part of the telescopic casing 132. Herein, the strap fastening subassembly 135 is positioned at the distal end 250 of the telescopic casing 132 and the raised attachment region 200 is formed at the proximal end 260 of the telescopic casing 132.

A pair of cavities 300 and 310 are formed adjacent to the raised attachment region 200. A first cavity 300 is sized to house the first brake pad 220, where the first clamp key 230 operates as a sidewall for the first cavity 300 and is configured to support the first brake pad 220 partially residing within the first cavity 300. Similarly, the second cavity 310 is sized to house the second brake pad 225, where the second clamp key 240 operates as a sidewall for the second cavity 310 and is configured to support the second brake pad 225 partially residing within the second cavity 310. Both the first clamp key 230 and the second clamp key 240 are configured to securely retain the first brake pad 220 and the second brake pad 225 in an elevated position so as to enable the first strut member 152 to be inserted within the telescopic casing 132 and positioned under the first and second brake pads 220/225. The top surfaces 222/227 of the first and second brake pads 220/225 extend above the top surface 133 of the telescopic casing 132.

As shown in FIG. 3, the top surface 133 of the telescopic casing 132 includes a depressed area 320 and a protrusion 330 positioned along a distal edge 332 of the raised attachment region 200. The protrusion 330 is adapted to engage with a snap lock 342 which may be positioned at a point of intersection of the first and second arms 270/271 (adjacent to the raised attachment region 200) when the tightening lever 134 is placed in a locked state. A proximal portion 340 along a perimeter of a junction region 350 of the tightening lever 134 may be positioned to reside within the depressed area 320. The depressed area 320 and the angular orientation of an edge 344 of a distal portion 346 of the tightening lever 134 allows a finger to be slid between the distal portion 346 and the depressed area 320 to enable the user to upwardly rotate the tightening lever 134 for placement into an unlocked state. The orientation of the cams positioned on the first and second arms 270/271 and the engagement of the snap lock 342 with the protrusion 330 collectively operate as a double locking mechanism that necessitates a greater amount of force in transitioning the tightening lever 134 from the locked-to-unlocked states than transitioning the tightening lever 134 from the unlocked-to-locked states. Alternatively, the distal portion 346 may include a detent for engagement into a notch within the depressed area 320.

Referring still to FIG. 3, each of the clamp keys 230/240 includes an attachment rod 232/242, a rotation prevention wall 233/243, a pair of brake pad support arms 235/245, and a base segment 236/246 extending from the back wall of the clamp key 230/240. With respect to the first clamp key 230 for illustrative purposes, the first attachment rod 232 is arranged for insertion through a pass-through aperture 272 of the first arm 270 of the tightening lever 134 and insertion into an opening of the first set of openings 262 in the raised attachment region 200. The rotation prevention wall 233 is inserted into another opening of the first set of openings 262 and is positioned to impede rotation of the tightening lever 134 from coming into contact with an upper portion 265 of the proximal end 260 of the telescopic casing 132.

As further shown, the pair of brake pad support arms 235 of the first clamp key 230 is adapted to retain separation between a bottom surface of the first brake pad 220 and a top surface 360 of the base segment 236. This separation is at least greater than the width of the first strut member 152, which allows the first strut member 152 to be positioned between the first brake pad 220 and the base segment 236. The second clamp key 240 features the same construction as the first clamp key 230, where the brake pad support arms 245 retain the second brake pad 225 to allow the first strut member 152 to be inserted thereunder. It is contemplated that the brake pads 220/225 can be inserted and secured by the brake pad support arms 235/245 prior to inserting the clamp keys 230/240 into the cavities 300/310 or may be inserted between the brake pad support arms 235/245 after the clamping keys 230/240 have been installed.

Referring still to FIG. 3, the telescopic casing 132 includes a slot 370 positioned proximately to one of the cavities 300/310 (e.g., the first cavity 300) for receipt of a stop 380 (e.g., a pin, dowel, threaded fastener, etc.). The stop 380 is arranged to come into contact with a tab 390 positioned along an edge 392 of the first strut member 152 and into the telescopic casing 132 to prevent removal of the first strut member 152 from the telescopic casing 132 after its insertion.

### IV. Telescopic Brake Assembly Components

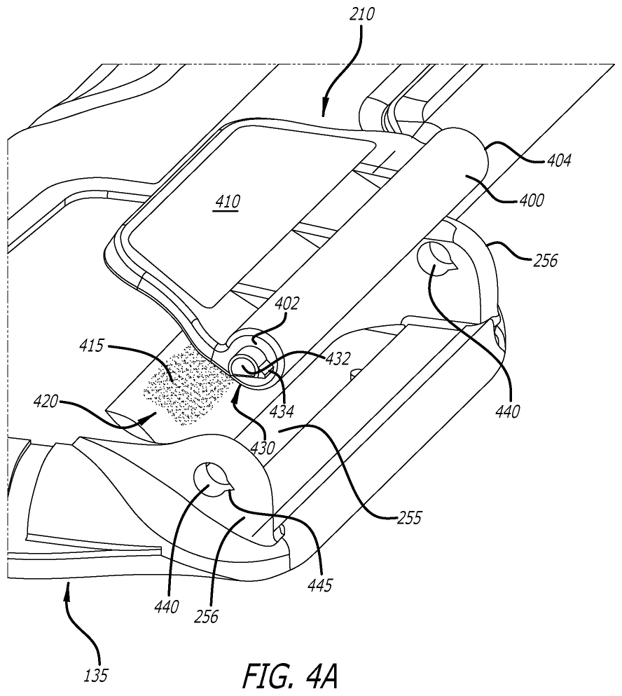

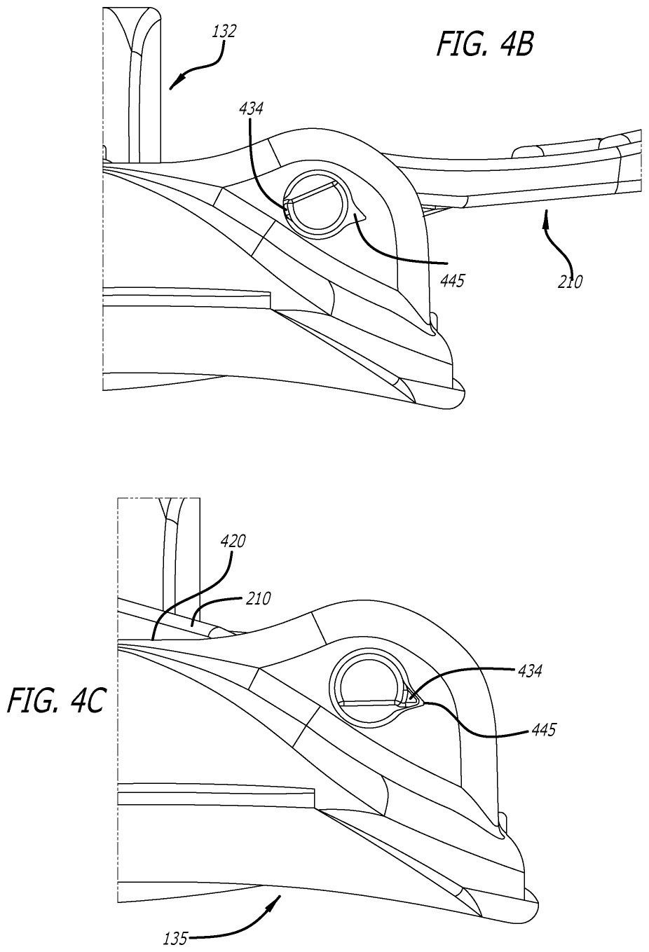

Referring now to FIG. 4A, an exemplary embodiment of the strap clamp 210 configured to attach to the clamp holder 256 integrated as part of the first strap fastening subassembly 135 of FIG. 1 is shown. More specifically, the first strap fastening subassembly 135 includes the clamp holder 256 positioned on opposite sides of second strap opening 255. The strap clamp 210 includes a rotational lock cylinder 400 and a pressure plate 410 to exert force against a strap fed through the second strap opening 255 when the strap clamp 210 is set into a locked state. Although not shown, additional fasteners 415 (e.g., hook/loop material, etc.) may be positioned along an edge 420 bordering the second strap opening 255.

As shown in FIGS. 4A-4C, the ends 402 and 404 of the rotational lock cylinder 400 may include locking guide members 430. The locking guide members 430 may be deployed as bosses 432, which are configured to reside within corresponding openings 440 formed within the clamp holder 256. As shown, the openings 440 are formed identical to the periphery contours of the bosses 432. For this illustrative embodiment, the bosses 432 are semi-circular in shape with a locking detent 434, which engages with a detent pocket 445 formed within an opening 440 created as part of the clamp holder 256.

As shown in FIG. 4B, the strap clamp 210 is positioned in a locked (closed) state in which the locking detent 434 is disengaged from the detent pocket 445 due to rotation of the strap clamp 210 away from the telescopic casing 132. In the locked state, the strap clamp 210 applies pressure to secure the strap fed through the second strap opening 255. In contrast, as shown in FIG. 4C, the strap clamp 210 is positioned in an unlocked state in which the locking detent 434 is engaged and resides within the detent pocket 445, when the strap clamp 210 generally rests against the edge 420 bordering the second strap opening 255. Hence, the transition of the strap clamp 210 from an opened (engaged) state to a closed (disengaged) state requires enough force to disengage the locking detent 434 from the detent pocket 445. This retains the strap clamp 210 in a default “opened” state to allow the strap to be freely moved through the second strap opening 255 until a sufficient force is exerted to remove the locking detent 434 from the detent pocket 445 to secure the strap.

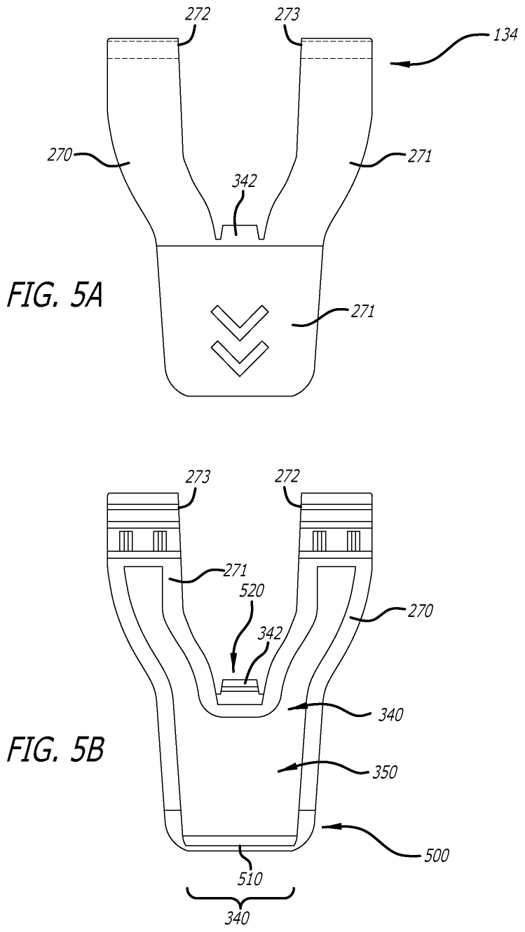

Referring now to FIG. 5A, a plan (top) view of an exemplary embodiment of the tightening lever 134 for the first telescopic brake assembly 130 of FIG. 3 is shown. Herein, the tightening lever 134 includes the first arm 270 and the second arm 271 that extend outwardly from a shared junction region 350. The first arm 270 features a distal end having the first pass-through aperture 272 while the second arm 271 includes a distal end having the second pass-through aperture 273. The first and second arms 270 and 271 of the tightening lever 134 are separated by prescribed distances for placement on alternative lateral sides of the raised attachment region 200.

As shown in FIG. 5B, a bottom view of the tightening lever 134 of FIG. 5A is shown. As described above, the distal ends of the first arm 270 and the second arm 271 feature pass-through apertures 272 and 273. Additionally, a distal end 500 of the junction region 350 may have an upward sloping angular orientation 510 to assist the user in initiating upward movement as shown. Alternatively, the proximal portion 520 at the junction region 350 features the snap lock 342, namely a fastener formed to establish a coupling (e.g., snap fit) with the protrusion 330 extending from the raised attachment region 200 as shown in FIG. 3. However, as an alternative embodiment, the distal end 500 of the junction region 350 may feature a detent including a fastener with an angled undercut 510 formed to establish a coupling (e.g., snap fit) with the notch of FIG. 3 positioned on the top surface 133 of the telescopic casing 132 as shown in FIG. 3.

Referring now to FIG. 6A, a detailed illustration of a clamp key of a telescopic brake assembly of FIG. 3, such as the second clamp key 240 for the first telescopic brake assembly 130 for example, is shown. Herein, the second clamp key 240 includes the back wall 241 with the attachment rod 242, the rotation prevention wall 243, a pair of brake pad support arms 245, and a base segment 246 extending therefrom. The attachment rod 242 is positioned on an upper region 600 of the back wall 241 for insertion into both (i) the pass-through aperture 273 of the second arm 271 of the tightening lever 134 and (ii) a first opening of the second set of openings 264 formed within the raised attachment region 200. The attachment rod 242 is configured to retain a proper orientation of the tightening lever 134 when attached to the raised attachment region 200. The rotation prevention wall 243 is arranged for insertion into a second opening of the second set of openings 264, where the rotation prevention wall 243 is positioned laterally and below the attachment rod 242. Herein, the rotation prevention wall 243 is positioned to preclude rotation of the tightening lever 134 so to avoid exceeding a prescribed degree of rotation from the top surface 133 of the telescopic casing 132 proximate to the distal end 250 as shown in FIGS. 2A & 11B. As an illustrative example, the prescribed degree of rotation may range from 135 degrees to 170 degrees.

As further shown in FIGS. 6A-6B, the pair of brake pad support arms 245 are positioned between the attachment rod 242 and the base segment 246. The pair of brake pad support arms 245 are positioned along edges 610 of the back wall 241 to provide an area 620 for retention of the brake pad 225. The area 620 may be defined by a recess 630 formed on an inner surface of the back wall 241, a ledge member 632 partially formed by the recess 630, and/or inner surfaces 634/636 of the brake pad support arms 245. The area 620 is sized to receive and retain the brake pad 225 of FIG. 3 while maintaining a spacing 640 between the area 620 and a top surface 645 of the base segment 246. The spacing 640 is sized with a distance at least equal to the width of the first strut member 152 of FIG. 3.

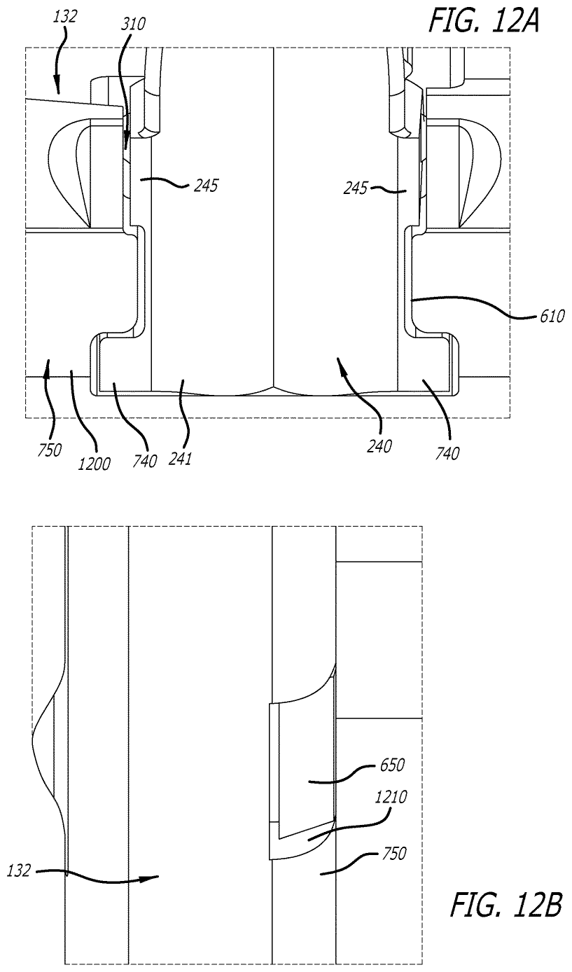

Referring to FIG. 6B, a plan view of the clamp key 240 of FIG. 6A is shown. Herein, the area 620 to retain the brake pad 225 is defined by the inner surface of the back wall 241 (e.g., recess 630), the ledge member 632 partially formed by the recess 630, and/or the inner surfaces 634/636 of the brake pad support arms 245. As shown in FIG. 6C, the base segment 246 includes an angled undercut 650 formed at an edge 652 of the base segment 246. The undercut 650 is structured to establish a coupling (e.g., snap fit) with a notch along a rail member forming a portion of the telescopic casing 142 as shown in FIGS. 12A & 14C for example.

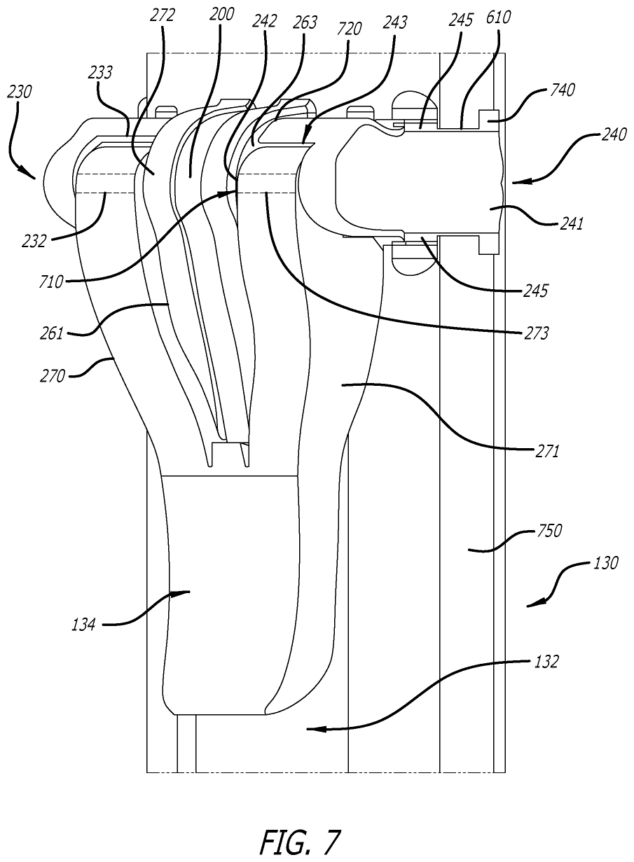

Referring now to FIG. 7, a perspective view of the tightening lever 134 operating as a fastening mechanism for the first telescopic brake assembly 130 of FIG. 3 is shown. Herein, the tightening lever 134 is placed into a locked state in which the first arm 270 and the second arm 271 are configured to straddle the raised attachment region 200 of the telescopic casing 132. As shown, the first arm 270 is positioned between the first clamp key 230 and the raised attachment region 200 and is coupled thereto by the first attachment rod 232 inserted through both the pass-through aperture 272 located on the distal end of the first arm 270 and an opening located on the first lateral side 261 of the raised attachment region 200. The rotation prevention wall 233 is inserted through a second opening on the first lateral side 261 of the raised attachment region 200.

Similarly, the second arm 271 of the tightening lever 134 is position between the second clamp key 240 and the raised attachment region 200. The attachment rod 242 associated with the second clamp key 240 is inserted through the pass-through aperture 273 of located on the distal end of the second arm 271 and an (first) opening 710 of the second set of openings 264 on the second lateral side 263 of the raised attachment region 200. The rotation prevention wall 243 is inserted through a (second) opening 720 of the second set of openings 264 on the second lateral side 263 of the raised attachment region 200.

Additionally, as shown in FIG. 7, the back wall 241 of the second clamp key 240 features a flared bottom member 740, which extends beyond the edges 610 of the back wall 241 between the bottom member 740 and the pair of brake pad support arms 245. The bottom member 740 provides lateral stability that provides enhanced coupling of the tightening lever 144 to the telescopic casing 142. The back wall 241 is adapted to be generally flush with an outer edge of a rail member 750 of the telescopic casing 142 through a snap fit connection of the base segment 246 to the rail member 750 to prevent unintended movement caused by rotation of the tightening lever 144.

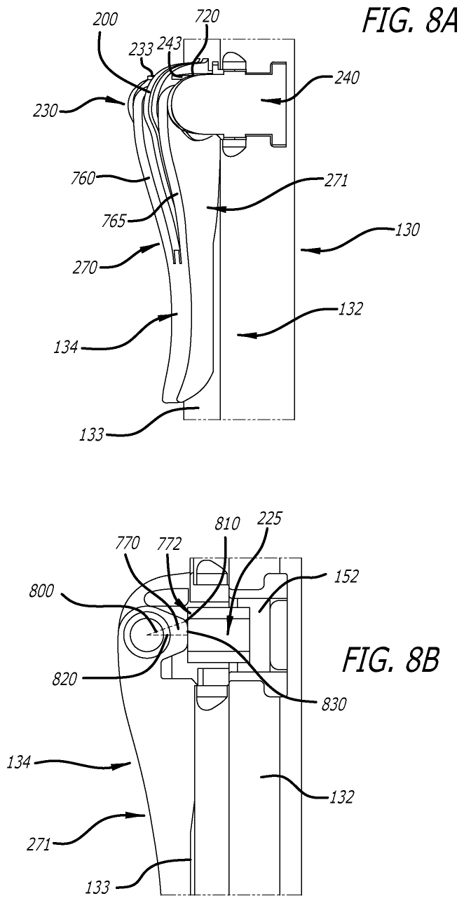

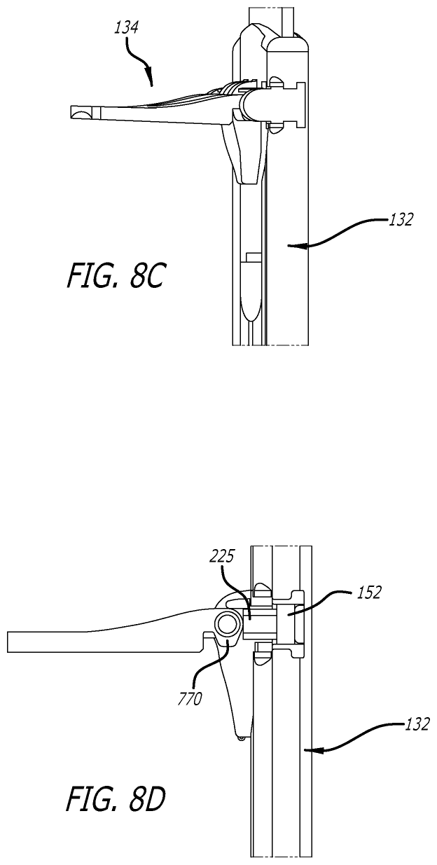

Referring to FIG. 8A, a lateral (side) view of the first telescopic brake assembly 130 of FIG. 1 is shown, where the tightening lever 134 is positioned in a locked state resting on the top surface 133 of the telescopic casing 132. According to this embodiment, the rotation prevention wall 243 of the second clamp key 240 is shown inserted into the second opening 720 of the second set of openings 264 formed within the raised attachment region 200. The rotation prevention walls 233/243 associated with the first and second clamp keys 230/240 provide a structure to preclude rotation of the tightening lever 134 beyond a prescribed degree of rotation. At that point, a top surface 765 of the second arm 271 establishes contact with the rotation prevention wall 243 and is prevented from further rotation. The same mechanism is set forth with the first clamp key 230 in which the rotation prevention wall 233 precludes rotation of the first arm 270 once a top surface 760 of the first arm 270 of the tightening lever 134 makes contact with the rotation prevention wall 233.

Referring to FIG. 8B, a lateral side view of the first telescopic brake assembly 130 of FIG. 8A without installation of the second clamp key 240 is shown. Herein, the second arm 271 of the tightening lever 134 includes a cam 770 oriented to make contact with a top surface 772 of the brake pad 225 when placed in a locked state. As shown, the cam 770 is configured to depress the brake pad 225 a prescribed distance to establish secure contact with a top surface of the first strut member 152 (see FIG. 1) to prevent longitudinal (sliding) movement of the first strut member 152 into or from the telescopic casing 132. The brake pad 225 is positioned in an elevated state by the second clamp key 240 so that the cam 770 engaged the brake pad 225 above the top surface 133 of the telescopic casing 132.

As further shown in FIG. 8B, a first radial distance 800 (e.g., distance from an axis of rotation of the tightening lever 134 (or the axial center of the pass-through aperture) to a proximal (top) corner portion 810 of the cam 770) is greater than a second radial distance 820 (e.g., a distance from the axis of rotation of the tightening lever 134 (or the center of the pass-through aperture) to a flat segment 830 of the cam 770), where the brake pad 225 is seated and engaged. Hence, to place the tightening lever 134 into a locked state, the brake pad 225 would need to overcome the longer, proximal corner portion 810 before settling onto the flat segment 830. As the cam 770 features a greater radial distance to the proximal corner portion 810 than the flat segment 830, once the brake pad 225 is engaged, the cam layout effectively operates as a locking feature by retaining the tightening lever 134 in the horizontal position and preventing the tightening lever 134 from being upwardly rotated.

However, as shown in FIG. 8C, the tightening lever 134 may be placed into an unlocked state in which the cam 770 disengages from the brake pad 225, which causes the brake pad 225 to rise as shown in FIG. 8D. As a result, the brake pad 225 disengages from the first strut member 152, which allows the first strut member 152 to be moved proximally and distally within the telescopic casing 132.

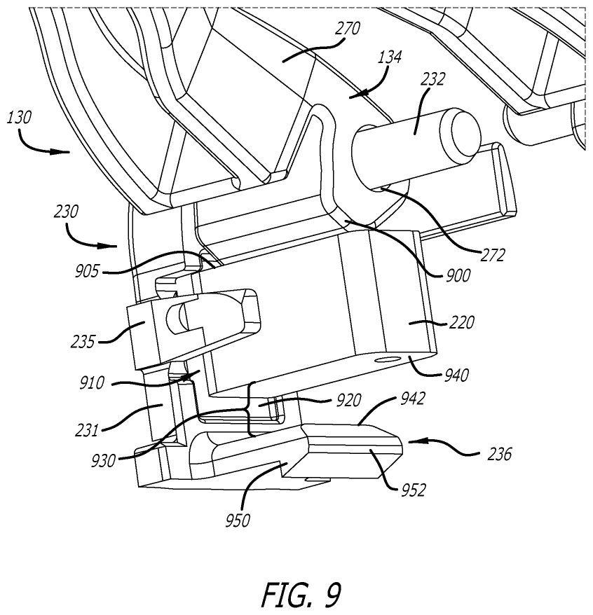

Referring now to FIG. 9, a perspective view of the first clamp key 230 (having the same configuration as the second clamp key 240) engage with the tightening lever 134 of the first telescopic brake assembly 130 is shown. Herein, the first attachment rod 232 of the first clamp key 230 is inserted through the pass-through aperture 272 formed within the first arm 270 of the tightening lever 134. This allows for rotational movement of the first arm 270. The first arm 270 includes a cam 900, which is sized to make contact with a top surface 905 of the brake pad 220 and apply downward forces to lower the brake pad 220 as the tightening lever 134 is being placed into the locked state. The brake pad 220 is maintained within an area 910 defined by a recess 920 formed on an inner surface of the back wall 231 and/or inner surfaces of the brake pad support arms 235. The area 910 provides a spacing 930 between a bottom surface 940 of the brake pad 220 and a top surface 942 of the base segment 236, which is sufficient in dimension to slide the first strut member 152 therein. The first strut member 152 is secured (and stationary) upon placement of the tightening lever 134 into a locked state.

Additionally, as described above for the second clamp key 240, the base segment 236 includes an angled undercut 950 formed at an edge 952 of the base segment 236. The undercut 950 is structured to establish a coupling (e.g., snap fit) with a notch along a rail member forming a portion of the telescopic casing 132, as further shown in FIGS. 12A & 14C for example.

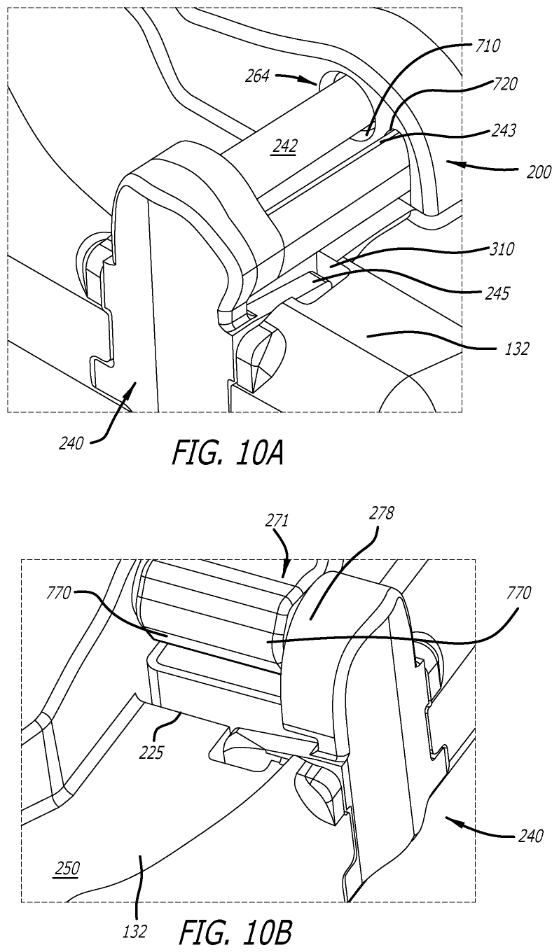

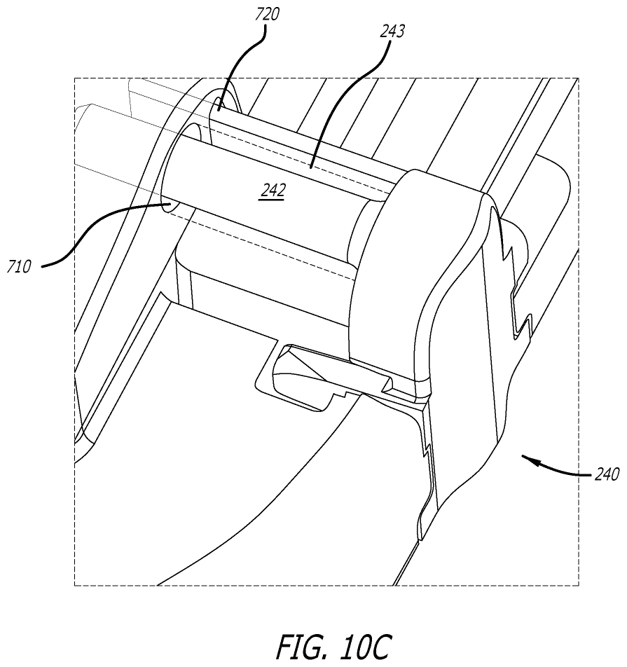

Referring to FIG. 10A-10C, perspective views of the second clamp key 240 of FIGS. 6A-6C with the attachment rod 242 inserted into the first opening 710 of the second set of openings 264 formed in the raised attachment region 200. The rotation prevention wall 243 of the second clamp key 240 is inserted into the second opening 720 of the second set of openings 264. The second clamp key 240 also features the brake pad support arms 245 positioned to reside within the cavity 310 associated with the telescopic casing 132.

As further shown in FIGS. 10B-10C, another perspective view of the second clamp key 240 of FIG. 10A is shown. Herein, the attachment rod 242 of the second clamp key 240 is inserted through the pass-through aperture 273 in the second arm 271 of the tightening lever 134 currently in an unlocked state. Herein, the tightening lever 134 of FIG. 1 is oriented with a degree of rotation greater than 90° from the distal end 250 of the telescopic casing 132. As shown, the brake pad 225 is visible and disengaged from the cam 770 present as part of the second arm 271 of the tightening lever 134.

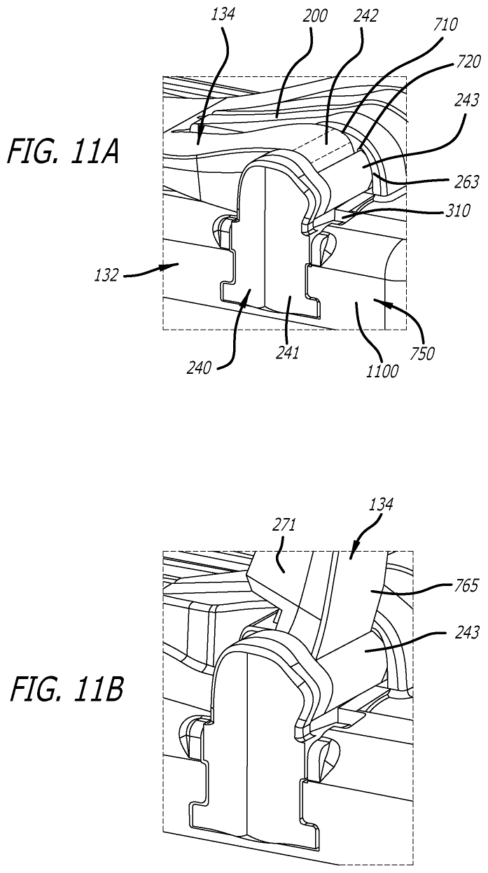

Referring to FIG. 11A, a perspective view of the second clamp key 240 of FIGS. 6A-6C inserted into the cavity 310 formed in the telescopic casing 132 is shown. Herein, the back wall 241 of the second clamp key 240 is generally aligned with a lateral surface 1100 of the rail member 750 of the telescopic casing 132 and the tightening lever 134 is positioned in a locked state. The attachment rod 242 is inserted through the pass-through aperture 273 located on the distal end of the second arm 271 and the first opening 710 on the second lateral side 263 of the raised attachment region 200. The rotation prevention wall 243 is inserted through the second opening 720 on the second lateral side 263 of the raised attachment region 200.

As shown in FIG. 11B, upon rotation of the tightening lever 134 towards the proximal end of the telescopic brake assembly from the locked state and its rotation, the rotation prevention wall 243 prevents rotation of the tightening lever 134 beyond a prescribed degree of rotation. As shown, upon undergoing the prescribed degree of rotation, the top surface 765 of the second arm 271 would contact the rotation prevention wall 243 and halt further rotation of the second arm 271 (and the tightening lever 134). The same mechanism would be adapted for the first clamp key 230 preventing rotation of the first arm 270 (and the tightening lever 134) beyond the prescribed degree of rotation governed by the placement of the rotation prevention wall 233 associated with the first clamp key 230.

Referring to FIG. 12A, a more detailed rear view of the second clamp key 240 of FIG. 11A is shown. The back wall 241 of the second clamp key 240 features the bottom member 740, which extends beyond the edges 610 of the back wall 241 between the bottom member 740 and the pair of brake pad support arms 245. The bottom member 740 enhances lateral stability of the tightening lever when installed within the cavity 310. The back wall 241 is adapted to be generally flush with an outer edge 1200 of the rail member 750 of the telescopic casing 132 through a snap fit connection of the base segment 246 to the rail member 750 as shown in FIG. 12B. In particular, the angled undercut 650 formed at the edge of the base segment 246 (see FIGS. 6A-6C) is structured to establish a coupling (e.g., snap fit) with a notch 1210 along the rail member 750 forming a portion of the telescopic casing 132.

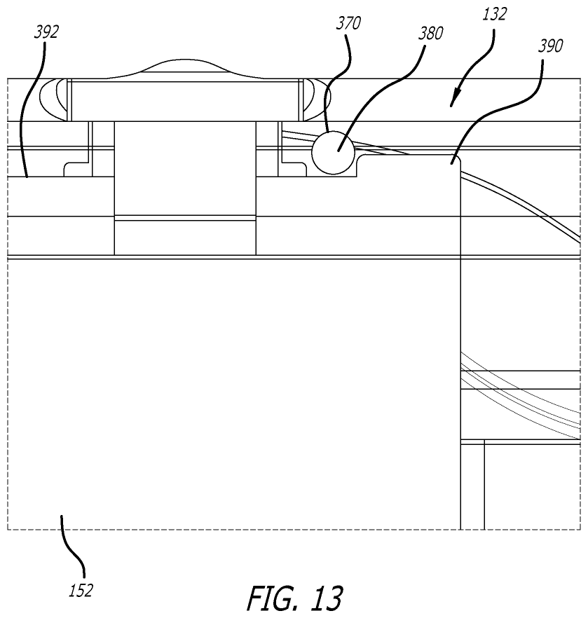

Referring now to FIG. 13, a plan view of an exemplary embodiment of the stop 380 inserted into the slot 370 formed in the telescopic casing 132 is shown. Herein, the stop 380 is sized and positioned to prevent removal of the first strut member 152. More specifically, the stop 380 (e.g., a pin, dowel, threaded fastener, etc.) is arranged to come into contact with the tab 390 positioned along the edge 392 of the first strut member 152 when maximum extension of the first strut member 152 (e.g., maximum removal from the telescopic casing 132) is achieved. The stop 380 is inserted after the first strut member 152 has been inserted into the telescopic casing 132 so that the tab 390 is inserted beyond the slot 370. Thereafter, the stop 380 may be inserted into the slot 370 to operate as a stop mechanism. The stop 380 may be permanently secured to the telescopic casing 132 (e.g., heat staking) or may be removably secured to the telescopic casing 132 (e.g., the stop 380 is threaded and the slot 370 is threaded to receive the stop 380).

### V. Telescopic Brake Assembly Operability

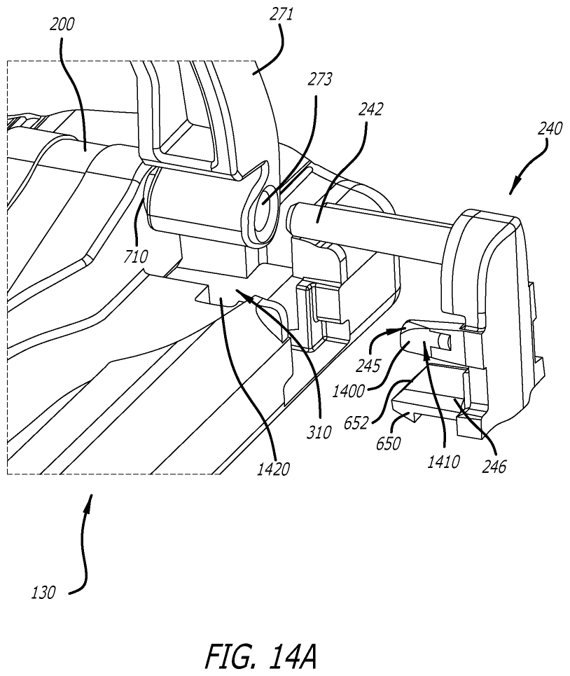

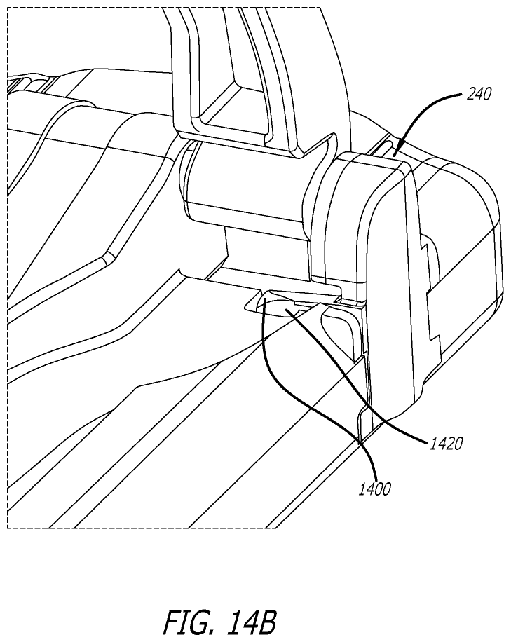

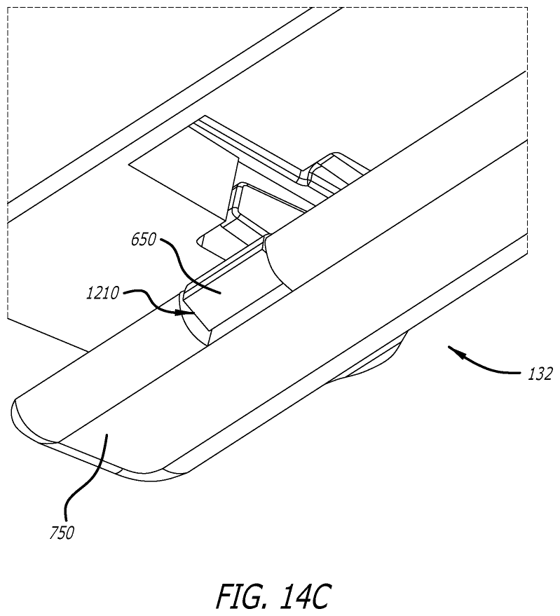

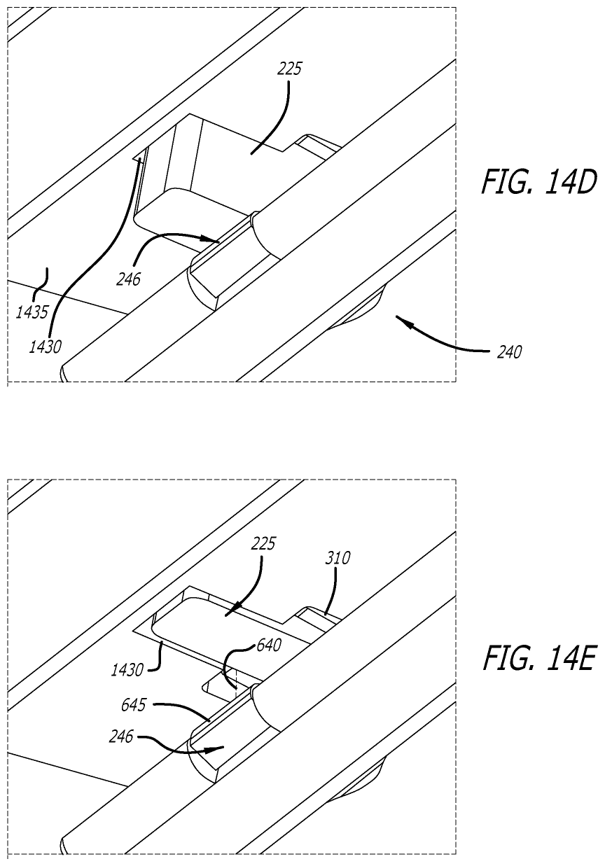

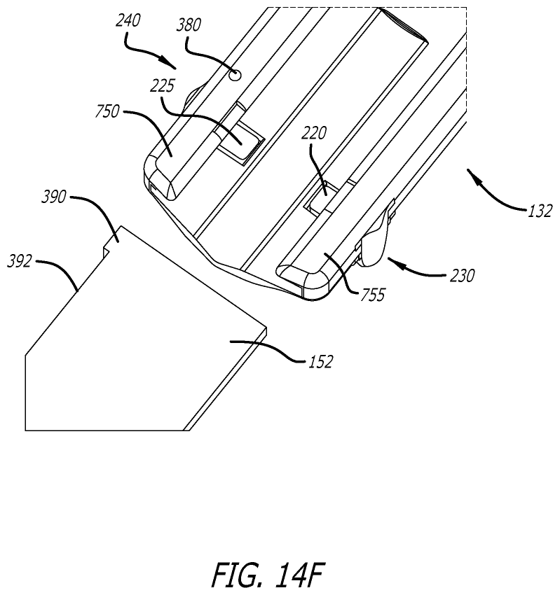

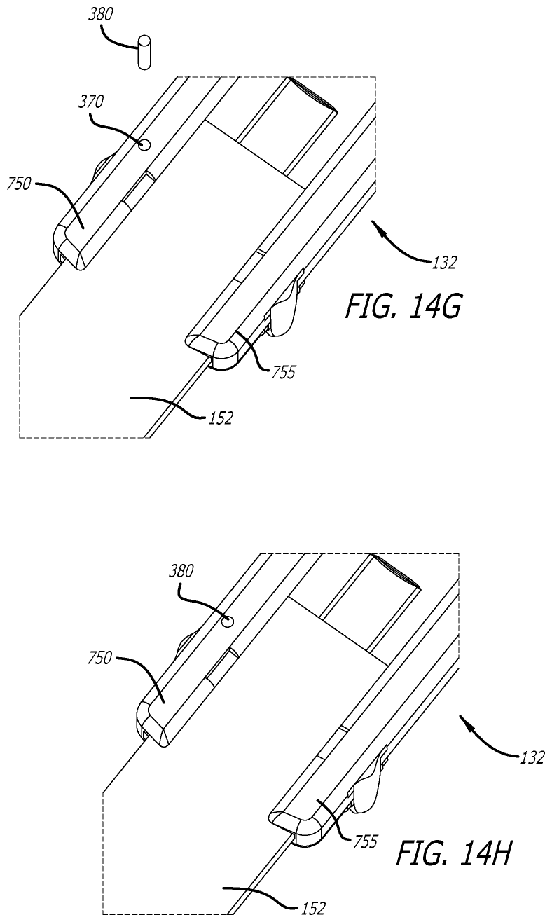

Referring now to FIGS. 14A-14H, an exemplary sequence of operations for assembly of the telescopic brake assembly of FIG. 1. Although the assembly of the telescopic brake assembly illustrated in FIGS. 14A-14H are directed to operations involving one of the pair of clamp keys (e.g., the second clamp key 240) along with its corresponding brake pad (e.g., brake pad 225) for simplicity, it is contemplated that some or all of these operations may be performed for the other clamp key (e.g., the first clamp key 230) to produce a telescopic brake assembly (e.g., first telescopic brake assembly 130).

Initially, an attachment rod for each of the clamp keys is aligned with a corresponding arm of the tightening lever and a corresponding opening within the raised attachment region 200. For example, as shown in FIGS. 14A-14B, the attachment rod 242 for the second clamp key 240 is aligned and inserted through the pass-through aperture 273 of the second arm 271 of the tightening lever 134 and the first opening 710 formed in the raised attachment region 200. Hence, the second clamp key 240 is inserted into the cavity 310. Upon insertion into the cavity 310, the brake pad support arms 245 are initially compressed inward and relax so that outer sidewall 1410 prevents unintentional dislodgement of the second clamp key 240, the angled undercut 650 formed at the edge 652 of the base segment 246 couples the notch 1210 placed along the rail member 750 forming a portion of the telescopic casing 132 as shown in FIG. 14C. As an optional feature, the sidewalls 1410 may include a protrusion 1400 located on the outer sidewall 1410 of the brake pad support arms 245, which are configured to reside within complementary notches 1420 forming the cavity 310 to further assist in preventing unintentional dislodgement of the second clamp key 240.

Referring to FIGS. 14D-14E, After Installation of the Second Clamp Key 240, the brake pad 225 is inserted within an opening 1430 formed on a bottom side 1435 of the telescopic casing 132 for placement above the base segment 246 and between the brake pad support arms 245. At this point of installation, the top surface of the brake pad 225 extends above the cavity 310 and the spacing 640 between a bottom surface of the brake pad 225 and the top surface 645 of base segment 246 is created.

Referring now to FIG. 14F-14H, after the brake pads 220 and 225 maintained by the first clamp key 230 and the second clamp key 240 have been installed, a strut member (e.g., the first strut member 152) is slid between the rail members 750 and 755 formed as part of the telescopic casing 132. After the tab 390 positioned along the edge 392 of the first strut member 152 has passed the slot 370, the stop 380 may be inserted into the slot 370 to operate as a stop mechanism. Thereafter, the stop 380 may be secured to the telescopic casing 132 in a permanent (e.g., heat staking) or removable (e.g., inserted or threaded in the slot 370) manner.

### VI. Orthopedic Brace Donning Process

Referring to FIGS. 15A-15F, an exemplary sequence of operations for donning of the orthopedic brace 100 of FIG. 1 is shown. More detailed illustrations of a securement 1500 intended for retention within one or more of the strap clamps 210 of the orthopedic brace 100 into an open position at manufacture and during distribution are shown in FIGS. 15B-15D. The securement 1500 may be made of a plastic material and installed between the pressure plate 410 and the additional fasteners 415 for one or more of the strap clamps 210 such as strap clamps 210₁-210₄ shown in FIG. 15B.

Referring to FIGS. 15A-15B, for donning of the orthopedic brace 100, the buckles 195-198 are unclipped to place the orthopedic brace 100 into an open state, where the orthopedic brace 100 is arranged to lie flat with pads of the cuffs facing upward. The telescopic brake assemblies 130, 140, 160 and 170 are released for adjustment of the corresponding telescopic casings 132, 142, 162 and 172. After the orthopedic brace 100 is positioned a leg of a wearer with the first joint control hinge member 150 and the second joint control hinge member 180 generally centered at the knee, ensuring calf pads 1530 face the foot. Thereafter, the telescopic casings 132, 142, 162 and 172 are adjusted to the correct length, and the tightening levers 134, 144, 164 and 174 are closed to lock the length.

Thereafter, as still shown in FIGS. 15A-15B, the orthopedic brace 100 is wrapped around both sides of the leg, retaining orientation of the orthopedic brace 100 and centering the joint control hinge members at the knee joint when the orthopedic brace 100 is implemented as a knee brace. Thereafter, according to one embodiment of the disclosure, lateral straps 191 and 192 may be configured to attach the first lateral brace assembly 110 to the second lateral brace assembly 120, where the tightening/loosening of the straps 191 and 192 also tightens or loosens the orthopedic brace 100 around a body part (leg) of the user. More specifically, each buckle 196-197 of the straps 191-192 is configured for attachment to complementary fasteners 188-189 and loosely secured around the leg of the user. For example, the buckle 196 associated with a second strap 191 may be coupled to a complementary fastener 188 located on the strap retention subassembly 166 for the third telescopic brake assembly 160. All of the straps 190-193 may be attached in a similar manner, where straps 191 and 192 closest to the knee are loosely fastened to preliminarily secure alignment and the remaining straps 190 and 193 are also loosely fastened to complete the provisional fit.

Thereafter, as shown in FIGS. 15C-15D, for each securement 1500, a first cutout tab 1510 may be coupled to an edge of the second strap opening 255 of FIG. 4A or a second cutout tab 1520 may rest on a top surface of the pressure plate 410 and the remainder of the securement 1500 is fed through the second strap opening 255 of FIG. 4A. As shown, each plastic securement 1500 may be removed from its corresponding strap clamp. For instance, as shown in FIG. 15C, the securement 1500 may be removed from strap clamp 210₃ associated with the fourth strap fastening subassembly 146 by first grasping the securement 1500 behind the strap 192 and then removing it, repeating this for each securement positioned within each strap clamp situated in the strap fastening subassemblies 135, 136, 145, and 146.

Next, as shown in FIG. 15E, all straps 190-193 are tightened firmly using the strap clamps 210₁-210₄ so there is no backside slack around the circumference of the leg while the buckles 195-198 (e.g., hook strap clips) are fastened. Tighten all the straps 190-193 firmly, ensuring there is no slack around the circumference of the leg. Thereafter, as shown in FIG. 15F, final tightening is performed by pulling the straps 190-193 through the buckles 195-198, where the adjustment of the straps 190-193 through the strap clamps 210₁-210₄ and the buckles 195-198 may be conducted repetitively, with trimming of the straps 190-193 to a correct length if needed.

Each of the joint control hinge members 150 and 180 is configured through dedicated implementation features and set up steps: EG extension limit settings are selectable between −10° (hyperextension) and 70° by pulling and sliding a first stopping mechanism to the desired position; flexion limit settings are selectable between 0° and 120° by pulling and sliding a second stopping mechanism. The joint control hinge members 150 and 180 may be locked into a plurality of settings, such as from 0° to 120° flexion and −10° to 70° extension for example.

In the foregoing description, the invention is described with reference to specific exemplary embodiments thereof. Hence, it will be evident that certain components may be deployed within different types of sleeve-based orthoses and various modifications and changes may be made thereto without departing from the broader spirit and scope of the invention as set forth in the appended claims to be submitted at a later time.

What is claimed is:

1. A telescopic brake assembly comprising:
a telescopic casing including a first cavity, a second cavity, and a raised attachment region extending from a top surface of the telescopic casing;
a pair of brake pads, wherein a first brake pad of the pair of brake pads is partially inserted within the first cavity and a second brake pad of the pair of brake pads is partially inserted within the second cavity; and
a tightening lever including a pair of arms rotatably attached to the raised attachment region, wherein a first arm of the pair of arms and a second arm of the pair of arms extend outwardly towards a proximal end of the telescopic casing from a single point of intersection,
wherein the single point of intersection includes a snap lock configured to engage with a protrusion positioned along a distal edge of the raised attachment region to necessitate more force in transitioning the tightening lever from a closed state to an open state than transitioning the tightening lever from the open state to the closed state.

2. The telescopic brake assembly of claim 1, wherein the first arm includes a cam positioned to contact a top surface of the first brake pad when the tightening lever is placed in a locked state in which the first brake pad establishes contact with a top surface of a strut member inserted into the telescopic casing to prevent longitudinal movement of the strut member.

3. The telescopic brake assembly of claim 2, wherein a first radial distance extending from an axis of rotation of the tightening lever to a proximal corner portion of the cam is greater than a second radial distance being a distance extending from the axis of rotation to a flat segment of the cam, where the first brake pad is engaged with the strut member.

4. The telescopic brake assembly of claim 3, wherein the cam is configured such that the first brake pad overcomes the proximal corner portion before settling onto the flat segment when the tightening lever is placed into the locked state.

5. The telescopic brake assembly of claim 3, wherein the cam operates as a locking feature that retains the tightening lever in a horizontal position and prevents the tightening lever from being upwardly rotated when the first brake pad is engaged with the flat segment.

6. The telescopic brake assembly of claim 2, further comprising:
a first clamp key including a first back wall with a first attachment rod, a first rotation prevention wall, a first pair of brake pad support arms, and a first base segment extending from the first back wall, wherein the first brake pad is included in a spacing formed by the first back wall, the first pair of brake pad support arms and the first base segment.

7. The telescopic brake assembly of claim 6, wherein the first attachment rod is arranged for insertion through a pass-through aperture of the first arm of the tightening lever and insertion into a first opening of a first set of openings formed within the raised attachment region.

8. The telescopic brake assembly of claim 7, wherein the first rotation prevention wall is arranged for insertion into a second opening of the first set of openings, the second opening positioned laterally and distally from the first opening.

9. The telescopic brake assembly of claim 6, wherein the first pair of brake pad support arms are configured to support the first brake pad with the strut member insertable between a bottom side of the first brake pad and a top surface of the first base segment.

10. The telescopic brake assembly of claim 6, wherein the first base segment includes an angled undercut formed at an edge of the first base segment, the angled undercut configured to snap into a corresponding slot on a bottom portion of the telescopic casing to securely attach the first clamp key to the telescopic casing.

11. The telescopic brake assembly of claim 6, wherein the first rotation prevention wall is positioned to preclude rotation of the tightening lever beyond a prescribed degree of rotation from the top surface of the telescopic casing.

12. A telescopic brake assembly comprising:
a telescopic casing including a cavity and a raised attachment region extending from a top surface of the telescopic casing, wherein the cavity is formed to partially house a strut member so that the telescopic casing is slidably adjusted longitudinally along the strut member;
a clamp key including an attachment rod, a back wall and a base segment extending from the back wall,
a brake pad positioned within a cavity of the raised attachment region in which the strut member is insertable between a bottom side of the brake pad and a top surface of the base segment; and
a tightening lever including a first arm rotationally coupled to the attachment rod, the first arm includes a cam having a layout operating as a locking feature that retains the tightening lever in a locked position and necessitates a greater amount of force to transition the tightening lever from a locked state to an unlocked state than to transition the tightening lever from the unlocked state to the locked state.

13. The telescopic brake assembly of claim 12, wherein a first radial distance from a axial center of a connection of the first arm to the raised attachment region to a proximal corner portion of the cam is greater than a second radial distance from the axial center of the connection of the first arm to the raised attachment region to a flat segment of the cam where the brake pad is seated when the tightening lever is in the locked state.

14. The telescopic brake assembly of claim 12, wherein the clamp key further comprises a rotation prevention wall partially inserted into the raised attachment region and positioned to preclude rotation of the tightening lever so as to avoid exceeding a prescribed degree of rotation, wherein upon undergoing the prescribed degree of rotation, a top surface of the first arm contacts the rotation prevention wall and halts further rotation of the first arm.

15. The telescopic brake assembly of claim 12, wherein the tightening lever comprises a pair of arms including the first arm and a second arm extending outwardly towards a proximal end of the telescopic casing from a junction region and rotatably attached to the raised attachment region,
wherein the junction region includes a snap lock configured to engage with a protrusion positioned along a distal edge of the raised attachment region to necessitate a greater amount of force to transition the tightening lever from the locked state to the unlocked state than to transition the tightening lever from the unlocked state to the locked state.

16. A telescopic brake assembly comprising:
a telescopic casing including a raised attachment region extending from a top surface of the telescopic casing, the raised attachment region having a first set of openings accessible from a first lateral side and a second set of openings accessible from a second lateral side;
a tightening lever including a first arm and a second arm extending from a junction region, wherein the first arm includes a first pass-through aperture and the second arm includes a second pass-through aperture;
a first clamp key including a first attachment rod arranged for insertion through the first pass-through aperture and into an opening of the first set of openings; and
a second clamp key including a second attachment rod arranged for insertion through the second pass-through aperture and into an opening of the second set of openings,
wherein each of the first arm and the second arm includes a cam configured to contact a corresponding brake pad when the tightening lever is placed in a locked state.

17. The telescopic brake assembly of claim 16, wherein a layout of the cam includes a first radial distance from an axis of rotation of the tightening lever to a proximal corner portion of the cam is greater than a second radial distance from the axis of rotation to a flat segment of the cam where the corresponding brake pad is seated and engaged.

18. The telescopic brake assembly of claim 17, wherein the layout of the cam operates as a locking feature that retains the tightening lever in a horizontal position when the corresponding brake pad is engaged with the flat segment.

19. The telescopic brake assembly of claim 16, wherein the junction region includes a snap lock positioned to engage with a protrusion extending from the raised attachment region when the tightening lever is placed in the locked state.

20. The telescopic brake assembly of claim 19, wherein engagement of the snap lock with the protrusion and a layout of the cam collectively operate as a double locking mechanism that necessitates more force in transitioning the tightening lever from the locked state to an unlocked state than transitioning the tightening lever from an unlocked state to the locked state.
